(19) United States
(12) Patent Application Publication
(10) Pub. No.: US 2021/0019299 A1
(43) Pub. Date: Jan. 21, 2021

(54) SYSTEM AND SERVER COMPRISING DATABASE SCHEMA FOR ACCESSING AND MANAGING UTILIZATION AND JOB DATA

(71) Applicant: AVEVA SOFTWARE, LLC, Lake Forest, CA (US)

(72) Inventors: Raghavendran Gobalakrishnan, Lake Forest, CA (US); Jeffrey Barkehanai, Lake Forest, CA (US)

(21) Appl. No.: 16/932,206

(22) Filed: Jul. 17, 2020

Related U.S. Application Data
(60) Provisional application No. 62/875,214, filed on Jul. 17, 2019.

(51) Int. Cl. G06F 16/23; G06F 16/22; G06F 16/21; G06F 9/52; G06F 9/46

(52) U.S. Cl. CPC G06F 16/2343; G06F 16/221; G06F 9/466; G06F 16/211; G06F 9/524; G06F 16/2282

(57) ABSTRACT

In some embodiments, the system is directed to an architecture that prevents transactional deadlocks by decoupling tables such that no transaction attempts to access the same table at the same time. In some embodiments, the system can identify an instance of a job running on an entity from a single record in the job history table without combing/truncating one or more records from an old schema. In some embodiments, the system improves performance by calculating the duration of a single job run on an entity from job history data as opposed to storing multiple data points during the time interval.

### CROSS REFERENCE

This application claims priority to U.S. Provisional Patent Application 62/875,214, filed Jul. 17, 2019, the entire contents of which are hereby incorporated by reference.

### BACKGROUND

The management of blocks of data for processing algorithms designed to monitor and run many analyses simultaneously (e.g., such as those used in industrial process systems such as manufacturing execution systems) is a significant challenge for many conventional computer systems and processes. To provide the most efficient performance, scalable and efficient data structures are needed that conform with a database schema for industrial process management logic applications, particularly those that access and manipulate utilization and job history data.

During the execution of filed commands, a transaction needs exclusive control of computing resources. If a first transaction is waiting on a second transaction to release exclusive control of a second resource (e.g., a record in a database), but the second transaction cannot release the control because it is waiting on the first transaction to release exclusive control of a first resource to complete its task, a deadlock occurs. Conventionally, the only way to resolve the deadlock is to cancel one of the first and second transactions to release its resources.

### SUMMARY

In some embodiments, the system is configured to reduce and/or eliminate transaction deadlocks that can occur during industrial processing monitoring and control by reducing and/or preventing coupling of databases (e.g., databases comprising tables of data), thereby preventing multiple transaction events from adversely affecting the same table. In some embodiments, the system is configured to reduce coupling between utilization and job history data. In some embodiments, the system is configured to eliminate overhead related to recalculation of utilization event durations that constantly change over time. In some embodiments, the system is configured to use query driven calculations (e.g., for utilization event duration) in place of actual values stored in calculated columns to improve read/write performance and/or to eliminate database contention (e.g., deadlocks and race conditions).

In some embodiments, the system includes a utilization history table and a job history table, where each table is decoupled from the other. In some embodiments, the utilization history table is configured to store utilization data. In some embodiments, the job history table is configured to store job history data. In some embodiments, the system includes a decoupled dynamic job history table configured store dynamic update values which include periodic data (e.g., hourly data).

In some embodiments, the system is configured to capture each instance of a job run in the job history table with one or more of a job context, job start, and/or job end times, as job history data. In some embodiments, the system is configured to calculate the duration of a single job run on an entity from the job history data. In some embodiments, the system is configured to vary shift information and utilization events independently by decoupling the shift information and utilization events for an entity, where the decoupling removes a transaction bottleneck. In some embodiments, the system is configured to eliminate persistence of utilization event duration by decoupling shift information and utilization events using separate job history tables and utilization tables, respectively.

In some embodiments, the system is configured to dynamically link utilization events to the shift that stated immediately prior to the start of the event. In some embodiments, the system is configured to provide periodic job history data using query triggered calculations. In some embodiments, the system is configured to execute one or more delay updates to the periodic job history table to allow related production and utilization events to settle for a period of time. In some embodiments, the system is configured to reduce the number of updates to the periodic job history table by executing one or more delay updates.

In some embodiments, the system is configured to reduce transaction deadlocks during manufacturing by not coupling two or more critical tables. In some embodiments, the system is configured to prevent multiple simultaneous events from adversely affecting the same table by providing decoupled critical tables and/or by not coupling two or more critical tables. In some embodiments, the system is configured to modify time data (i.e., shift times) without affecting utilization events and/or forcing an update of a utilization event.

In some embodiments, the system is configured to reduce maintenance overhead by not artificially splitting utilization events at the beginning of a new time period (e.g., a new shift). In some embodiments, the system is configured to eliminate the need to persist data (e.g., utilization data, job history data, and/or periodic data) by calculating utilization event duration in response to a query. In some embodiments, the system is configured calculating utilization event duration on the fly.

In some embodiments, the system is configured to reduce overhead for related processing during runtime when performing one or more operations including splitting, merging, updating, and/or deleting utilization events (e.g., scheduled maintenance tasks, shift changes, etc.) by providing decoupled tables and/or by not coupling two or more tables. In some embodiments, the system is configured to prevent negative durations by eliminating race conditions by not updating durations in one or more databases. In some embodiments, decoupling of job and utilization event tables and/or history eliminates the possibility of creating duplicate job history records identifying the same corresponding utilization event. In some embodiments, the system is configured to identify an instance of a job running on an entity from a single record in the job history table without combing/truncating one or more records from the old schema.

In some embodiments, the system is configured to delay periodic (e.g., hourly) time periods (“buckets”) in a dynamic job history table that includes production and utilization information for a predetermined period of time. In some embodiments, the period of time is 1-5 hours. In some embodiments, the period of time is 3 hours. In some embodiments, the period of time is a volatile time period. In some embodiments, the volatile time period includes a utilization state of a machine and/or entity and/or the production for jobs running on a machine and/or entity. In some embodiments, delaying periodic time periods eliminates one or more race conditions (i.e., multiple race condition classes) that arise from unnecessarily performing updates at very small intervals (e.g., <=1 second) which creates a process bottleneck. In some embodiments, the system includes a view (e.g., vw_tpm_status_data) that provides production and utilization information within a given period of time (e.g., up to the second). In some embodiments, at least a portion of the production and utilization information is calculated. In some embodiments, the view includes a secondary benefit of providing legacy support.

### DESCRIPTION OF THE DRAWINGS

FIG. 1 shows a portion the system architecture according to some embodiments.

FIG. 2 illustrates another portion the system architecture according to some embodiments.

### DETAILED DESCRIPTION

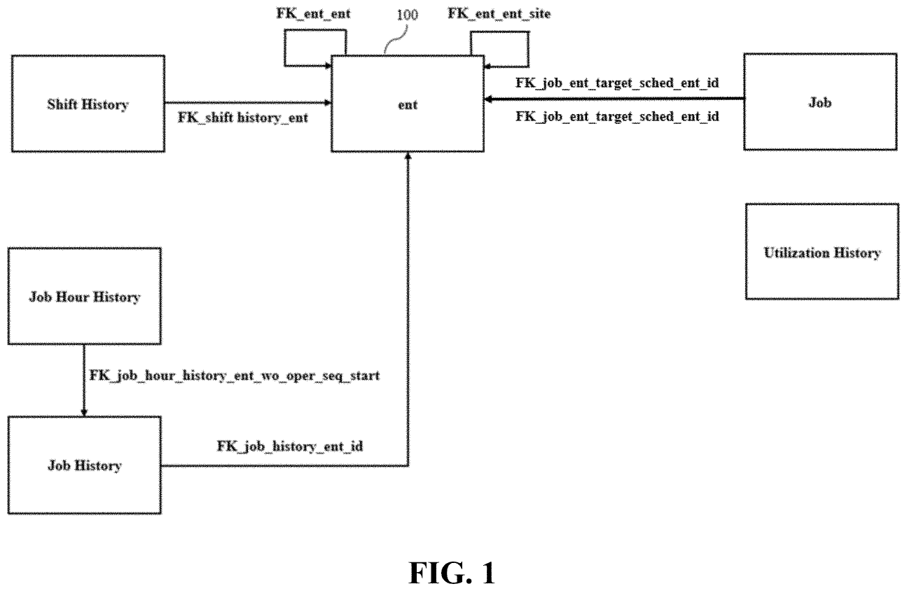

FIG. 1 shows a portion of the system architecture 10 and an entity 100 according to some embodiments. In some embodiments, the system architecture 10 can be achieved by at least partially decoupling utilization data and job history data. In some embodiments, procedures for the decoupling of utilization and job history data can include defining or preparing separate history tables for utilization and job history with the added distinction of at least one separate hourly or other periodic job history table that can be used for dynamic updates.

Some further embodiments of the invention include eliminating overhead (e.g., such as processor time, and/or interrupt time, and/or data cycle usage, and/or data storage usage) related to recalculation of utilization event durations that can constantly or periodically change over time.

Some embodiments include improved handling of utilization data on shift boundaries. Some embodiments include replacing calculated columns with query driven calculations (e.g., such as utilization event duration) that result in improved read/write performance, which eliminates database contention such as deadlocks and/or race conditions.

Some embodiments of the invention comprise program logic, that when executed by at least one processor of the system, captures each instance of a job run in a job history table with job context, and/or job start data, and/or job end time data, where a duration of a single job run on an entity (such as entity 100) is calculated from the job history table.

Some embodiments comprise program logic, that when executed by at least one processor of the system, can decouple shift information and utilization events for an entity 100 so they can vary independently, thereby removing a transactional bottleneck.

Some embodiments of the invention comprise program logic, that when executed by at least one processor of the system, eliminates at least one persistence of utilization event duration.

Some embodiments of the invention comprise dynamically linking utilization events to a shift that started immediately or shortly prior to the start of the event.

Some embodiments of the invention comprise replacing system calculated columns with query triggered system calculations regarding hourly or other periodic job history data.

Some embodiments of the invention comprise program logic, that when executed by at least one processor of the system, provide delayed updates to the job hour history table. In some embodiments, the system is configured to capture hourly data to allow related production and utilization events and allow the hourly data to settle for a period of time, thus reducing the number of updates by not updating the job hour history table for the period of time.

In some embodiments, program logic, that when executed by at least one processor of the system, provide a system where shift times are configured to be modified without affecting utilization events (i.e., without forcing an update of an event).

In some embodiments, comprise program logic, that when executed by at least one processor of the system, provide a system where utilization events are not artificially split at the beginning of a new shift, thus reducing maintenance overhead.

In some embodiments, program logic, that when executed by at least one processor of the system, calculate a utilization event duration on the fly that eliminates the need to persist the data, while also reducing the overhead for related processing during runtime when splitting, and/or merging, and/or updating and/or deleting utilization events (e.g., such as scheduled maintenance tasks, shift changes, etc.). In some embodiments, negative durations are no longer a concern, since problematic race conditions no longer exist because durations are not updated in the database.

In some embodiments, the implementation of one or more of the systems and methods described for decoupling of job and utilization event history eliminates instances of duplicate job history records identifying the same corresponding utilization event. In some embodiments, an instance of a job run on an entity is be easily identified from a single record in the job history table as opposed to combining or truncating multiple or many records.

In some embodiments, the implementation of one or more of the systems and methods described include updates to the hourly buckets, represented in the job hour history table, containing production and utilization information that are delayed. In some embodiments, the delay is by about three hours since the last three hours from the current time are volatile regarding both the utilization state of entity 100, and the production for jobs running on entity 100. In some embodiments, this can eliminate an entire class of race conditions which arise from unnecessarily performing updates at very small intervals (e.g., such as those performed with intervals of about one second or less than about one second duration), and that create a processing bottleneck. Furthermore, in some embodiments, a view (“vw_tpm_status_data”) can provide substantially near-real-time (up to around every second) production and utilization information, some of which is calculated by the system, and has the secondary benefit of providing legacy support.

In some embodiments, the system accounts for and/or processes program logic in using coordinated universal time (UTC). In some embodiments, this eliminates issues with entities residing in multiple time zones, and/or transactions occurring just before/after daylight saving time change, and/or with locations with half-hour and 15-minute offsets from UTC. In some embodiments, example scenarios can include using a Web interface to record/modify an event where the user's time zone is different from the Web Server time zone which may be different from the entity/equipment time zone.

In some embodiments, an example scenario comprises an event that is detected just before DST change and is sent to the database for processing, but the message is processed just after the DST change which causes ambiguity on the time of the event. In some embodiments, difficulties are encountered in editing events that cross a DST boundary where there is a need to know which local time to use (before or after a time change), especially during a United States Fall time change where the same local time occurs twice.

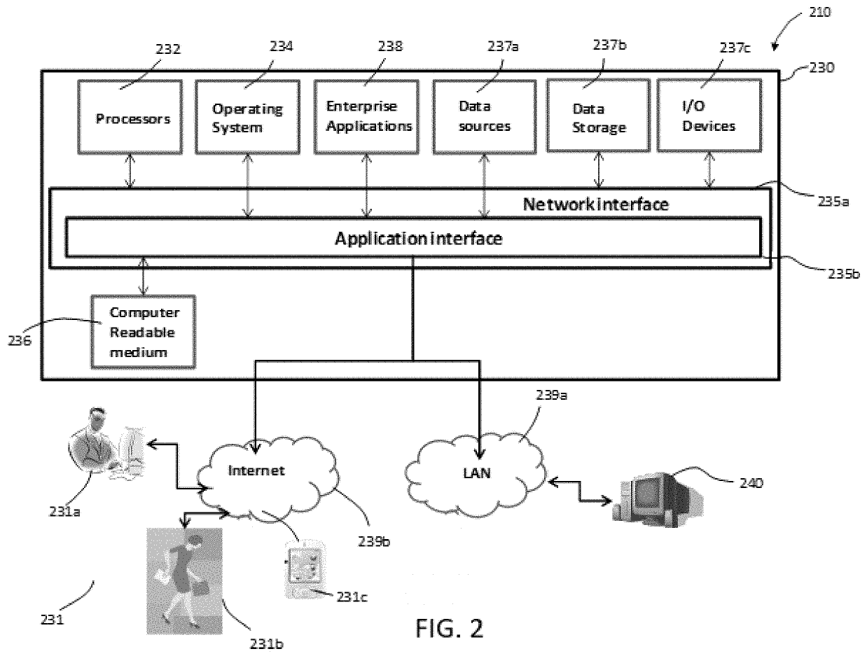

In some embodiments, the entity 100 of the system architecture 10 can be operatively coupled to the computer system 210 shown in FIG. 2 and/or the computer system 210 comprises the system architecture 10. In some embodiments, the computer system 210 includes and/or operates and/or processes computer-executable code of one or more of the above-mentioned program logic, software modules, and/or systems. Further, in some embodiments, the computer system 210 operates and/or displays information within one or more graphical user interfaces coupled to the system architecture 10 of FIGS. 1A-1B. In some embodiments, the computer system 210 can comprise a cloud server and/or can be coupled to one or more cloud-based server systems.

In some embodiments, the system 210 comprises at least one computer including at least one processor 232. In some embodiments, the at least one processor 232 includes a processor residing in, or coupled to, one or more server platforms. In some embodiments, the system 210 includes a network interface 235a and an application interface 235b coupled to the least one processor 232 capable of processing at least one operating system 234. Further, in some embodiments, the interfaces 235a, 235b coupled to at least one processor 232 are configured to process one or more of the software modules 238 (e.g., such as enterprise applications). In some embodiments, the software modules 238 include server-based software, and are configured to operate to host at least one user account and/or at least one client account, and/or are configured to transfer data between one or more of these accounts using the at least one processor 232.

With the above embodiments in mind, it should be understood that the invention can employ various computer-implemented operations involving data stored in computer systems. Moreover, the above-described databases and models described throughout can store analytical models and other data on computer-readable storage media within the system 210 and on computer-readable storage media coupled to the system 210. In addition, the above-described applications of the system can be stored on computer-readable storage media within the system 210 and on computer-readable storage media coupled to the system 210. These operations are those requiring physical manipulation of physical quantities.

Usually, though not necessarily, these quantities take the form of electrical, electromagnetic, or magnetic signals, optical or magneto-optical form capable of being stored, transferred, combined, compared and otherwise manipulated. In some embodiments, the system 210 comprises at least one computer readable medium 236 coupled to at least one data source 237a, and/or at least one data storage device 237b, and/or at least one input/output device 237c. In some embodiments, the system is embodied as computer readable code on a computer readable medium 236. In some embodiments, the computer readable medium 236 is any data storage device that can store data, which can thereafter be read by a computer system (such as the system 210). In some embodiments, the computer readable medium 236 is any physical or material medium that can be used to tangibly store the desired information or data or instructions and which can be accessed by a computer or processor 232. In some embodiments, the computer readable medium 236 includes hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 236 transmit or carry instructions to a computer 240 and/or at least one user 231, including a router, private or public network, or other transmission device or channel, both wired and wireless. In some embodiments, the software modules 238 is configured to send and receive data from a database (e.g., from a computer readable medium 236 including data sources 237a and data storage 237b that can comprise a database), and data can be received by the software modules 238 from at least one other source. In some embodiments, at least one of the software modules 238 is configured within the system to output data to at least one user 231 via at least one graphical user interface rendered on at least one digital display.

In some embodiments, the computer readable medium 236 is distributed over a conventional computer network via the network interface 235a where the system embodied by the computer readable code can be stored and executed in a distributed fashion. For example, in some embodiments, one or more components of the system 210 is coupled to send and/or receive data through a local area network (“LAN”) 239a and/or an internet coupled network 239b (e.g., such as a wireless internet). In some further embodiments, the networks 239a, 239b include wide area networks (“WAN”), direct connections (e.g., through a universal serial bus port), and/or other forms of computer-readable media 236, or any combination thereof.

In some embodiments, components of the networks 239a, 239b include any number of user devices such as personal computers including for example desktop computers, and/or laptop computers, or any fixed, generally non-mobile internet appliances coupled through the LAN 239a. For example, some embodiments include personal computers 240a coupled through the LAN 239a that are configured for any type of user including an administrator. Other embodiments include personal computers coupled through network 239b. In some embodiments, one or more components of the system 210 are coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some embodiments, the system 210 enables at least one user 231 to be coupled to access enterprise applications 238 via an I/O device 237c through LAN 239a. In some embodiments, the user 231 comprises a user 231a coupled to the system 210 using a desktop computer, and/or laptop computers, or any fixed, generally non-mobile internet appliances coupled through the internet 239b. In some embodiments, the user 231 comprises a mobile user 231b coupled to the system 210. In some embodiments, the user 231b uses any mobile computing device 231c to wireless coupled to the system 210, including, but not limited to, personal digital assistants, and/or cellular phones, mobile phones, or smart phones, and/or pagers, and/or digital tablets, and/or fixed or mobile internet appliances.

It is to be understood that the invention is not limited in its application to the details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Acting as Applicant's own lexicographer, Applicant defines the use of and/or, in terms of “A and/or B,” to mean one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

The discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein.

The detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include various methods, apparatuses (including computer systems) that perform such methods, and computer readable media containing instructions that, when executed by computing systems, cause the computing systems to perform such methods. For example, some non-limiting embodiments comprise certain software instructions and/or program logic stored on one or more non-transitory computer-readable storage devices that tangibly store program logic for execution by one or more processors of the system and/or one or more processors coupled to the system.

Some embodiments relate to improved data processing in electronic devices including, for example, an entity or machine such as a manufacturing execution system that provides a technological solution where users can more efficiently process and view and/or retrieve useful data based on improvements in capturing and manipulating utilization, job history, and job hour history data. For example, some embodiments generally describe non-conventional approaches for systems and methods that capture, manipulate utilization, job history, and job hour history data that are not well-known, and further, are not taught or suggested by any known conventional methods or systems. Moreover, in some embodiments, the specific functional features are a significant technological improvement over conventional methods and systems, including at least the operation and functioning of a computing system that are technological improvements. These technological improvements include one or more aspects of the systems and method described herein that describe the specifics of how a machine operates, which the Federal Circuit makes clear is the essence of statutory subject matter.

Some embodiments described herein include functional limitations that cooperate in an ordered combination to transform the operation of a data repository in a way that improves the problem of data storage and updating of databases that previously existed. In particular, some embodiments described herein include system and methods for managing single or multiple content data items across disparate sources or applications that create a problem for users of such systems and services, and where maintaining reliable control over distributed information is difficult or impossible.

The description herein further describes some embodiments that provide novel features that improve the performance of communication and software, systems and servers by providing automated functionality that effectively and more efficiently manages resources and asset data for a user in a way that cannot effectively be done manually. Therefore, the person of ordinary skill can easily recognize that these functions provide the automated functionality, as described herein, in a manner that is not well-known, and certainly not conventional. As such, the embodiments of the invention described herein are not directed to an abstract idea and further provide significantly more tangible innovation. Moreover, the functionalities described herein were not imaginable in previously-existing computing systems, and did not exist until some embodiments of the invention solved the technical problem described earlier.

Some embodiments include a system and method for arranging, structuring, and transmitting data or datasets in computer systems using one or more data streams that are created by separation of the data into a plurality of parts. In some embodiments, the plurality of parts can be stored on various components of the system and transmitted through one or more data channels as partial or complete data or datasets, each representing at least a portion of an overall dataset or plurality of datasets.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the description and figures herein.

We claim:

1. A system for eliminating transaction deadlocks comprising:
a computer comprising one or more processors and one or more non-transitory computer readable media, the computer readable media including instructions stored thereon that when executed by the one or more processors implement:
a utilization history table, and
a job history table;
wherein the utilization history table is configured to store utilization data;
wherein the job history table is configured to store job history data
wherein the utilization history table and the job history table are decoupled and/or separate tables; and
wherein the system is configured to reduce and/or eliminate transaction deadlocks by reducing and/or preventing coupling of databases thereby preventing multiple transaction events from adversely affecting the same table.

2. The system of claim 1,
wherein the system is configured to use query driven calculations for utilization event duration in place of actual values stored in calculated columns to improve read/write performance and/or to eliminate database deadlocks and/or race conditions.

3. The system of claim 1,
wherein the system includes a decoupled dynamic job history table configured store dynamic update values which include periodic data.

4. The system of claim 1,
wherein the system is configured to capture each instance of a job run in the job history table with one or more of a job context, job start, and/or job end times, as job history data.

5. The system of claim 1,
wherein the system is configured to calculate the duration of a single job run on an entity from the job history data.

6. The system of claim 1,
wherein the system is configured to vary shift information and utilization events independently by decoupling the shift information and utilization events for an entity, where the decoupling removes a transaction bottleneck.

7. The system of claim 1,
the system is configured to eliminate persistence of utilization event duration by decoupling shift information and utilization events using separate job history tables and utilization tables.

8. The system of claim 1,
wherein the system is configured to provide periodic job history data using query triggered calculations.

9. The system of claim 1,
wherein the system is configured to execute one or more delay updates to the periodic job history table to allow related production and utilization events to settle for a period of time.

10. The system of claim 1,
wherein the system is configured to reduce the number of updates to the periodic job history table by executing one or more delay updates.

11. The system of claim 1,
wherein the system is configured to modify time data without affecting utilization events and/or forcing an update of a utilization event.

12. The system of claim 1,
wherein the system is configured to reduce maintenance overhead by not artificially splitting utilization events at the beginning of a new time period.

13. The system of claim 1,
wherein the system is configured to eliminate the need to persist data by calculating utilization event duration in response to a query.

14. The system of claim 1,
wherein the system is configured to reduce overhead for related processing during runtime when performing one or more operations including splitting, merging, updating, and/or deleting utilization events by providing decoupled tables and/or by not coupling two or more tables.

15. The system of claim 1,
wherein the system is configured to prevent negative durations by eliminating race conditions by not updating durations in one or more databases.

16. The system of claim 1,
wherein the system is configured to identify an instance of a job running on an entity from a single record in the job history table without combing/truncating one or more records from an old schema.

17. The system of claim 1,
wherein the system includes a view that provides production and utilization information within a given period of time.

18. The system of claim 1,
wherein the system is configured to delay periodic time periods in a dynamic job history table that includes production and utilization information for a predetermined period of time.

19. The system of claim 18,
wherein the period of time is 1-5 hours.

20. The system of claim 18,
wherein the period of time is a volatile time period, and
wherein the volatile time period includes a utilization state of a machine and/or entity and/or the production for jobs running on a machine and/or entity.
